(19) United States
(12) Patent Application Publication
(10) Pub. No.: US 2022/0248917 A1
(43) Pub. Date: Aug. 11, 2022

(54) Air Blowing and Water Dispensing Shower System

(71) Applicant: Joi Duckery, Aurora, CO (US)

(72) Inventor: Joi Duckery, Aurora, CO (US)

(21) Appl. No.: 17/592,542

(22) Filed: Feb. 4, 2022

Related U.S. Application Data
(60) Provisional application No. 63/148,173, filed on Feb. 11, 2021.

(51) Int. Cl. A47K 10/48; E03C 1/04

(52) U.S. Cl. CPC A47K 10/48; E03C 1/0408

(57) ABSTRACT

The present invention relates to a plumbing fixture and a shower bathing system capable of dispensing water spray and drying air. More specifically, the plumbing fixture has a plurality of nozzles or openings for dispensing water and one or more central air vents for blowing out air. The air is produced by a blower and is carried to the air vents through an air carrying pipe. The showerhead has an integrated timer for calculating the time of water dispensing or cessation and is configured to automatically activate the blowing of air when the elapsed time matches a preconfigured value. The showerhead has proximity sensors for automatically deactivating the dispensing of water and stopping blowing out hot air.

### CROSS-REFERENCE TO RELATED APPLICATION

The present application claims priority to, and the benefit of, U.S. Provisional Application No. 63/148,173, which was filed on Feb. 11, 2021 and is incorporated herein by reference in its entirety.

### FIELD OF THE INVENTION

The present invention relates generally to the field of plumbing accessories and personal conveniences. More specifically, the invention relates to a novel shower system and showerhead capable of dispensing a water supply in a dispersal pattern, such as by a spray and blowing dry or hot air and providing a way for people to bathe, shower and then dry themselves off without having to use a towel. More specifically, the showerhead can manually or automatically blow dry or hot air. The plumbing accessory is available in multiple configurations and may be mounted to the wall, have an extension, and other features making it convenient for the user. Accordingly, the present disclosure makes specific reference thereto. Nonetheless, it is to be appreciated that aspects of the present invention are also equally applicable to other like applications, devices and methods of manufacture.

### BACKGROUND

By way of background, homes generally have showers in washrooms and bathrooms and each shower normally includes a showerhead or other feature that is designed to direct water in the form of a spray or other dispersal pattern on a person who seeks to wash or bathe themselves. The showerheads are in various forms, such as wall mounted and extendable from a fixed position, such as with an extension hose or other flexible attachment. The primary function of conventional showerheads is to apply or spray water on the person's body before applying soap, shampoo body wash and other materials prior to rinsing.

After the shower, a person usually has to use a towel to dry off. Otherwise, they have to dry off in the open air which may take some time. As such, a separate towel is usually required for each person to maintain personal hygiene. Further, the towels are required to be washed after a few uses. Constantly washing towels is not only unpleasant, but can affect the hygiene of other clothing being washed along with the towels. Often, a person going for the shower forgets to take in the towel and can be in an embarrassing situation in front of family members when they need to get assistance for someone to bring a towel. People desire a shower system and showerhead that can be used to wash and then dry themselves off by using a method such as blowing dry or hot air out of the plumbing fixture and eliminating the need for a towel after a shower.

Therefore, there exists a long felt need in the art for a plumbing fixture, such as a showerhead, that provides a way to dry off a person after a shower or bathing. There is also a long felt need in the art for a showerhead that can blow dry or hot air in addition to dispensing water. Additionally, there is a long felt need in the art for a plumbing fixture that functions and looks like a conventional showerhead or other fixture that one may find in a shower or bathing area. Moreover, there is a long felt need in the art for a plumbing fixture that eliminates the need of a towel to dry off after a shower or bathing. Further, there is a long felt need in the art for a plumbing fixture and an accessory for use in a shower or bathing area that can manually or automatically dispense water and blow dry or heated air on a person using the shower and after bathing. Finally, there is a long felt need in the art for a shower or bathing enclosure and plumbing fixture that offers a way for people to bathe, shower and then dry off without having to use a towel.

The subject matter disclosed and claimed herein, in one embodiment thereof, comprises a plumbing fixture for performing the dual function of dispensing water in a spray or other dispersal pattern and blowing dry or hot air. The plumbing fixture offers a way for people to bathe, shower and then dry off without having to use a towel. The plumbing fixture further includes a plurality of water nozzles for dispensing water in the form of a spray or other desired pattern and a plurality of air vents for blowing dry or heated air. Blowing dry or hot air can be manually activated by a user or automatically activated using a timer which is preconfigured with a timer value and is configured to calculate time from the activation of dispensing of water and when the dry air is automatically blown on reaching the timer value to the preconfigured value. The blowing of air may also be triggered within a short period of time after the water turns off or substantially immediately after the water ceases being dispensed. The water nozzles are coupled to a water carrying pipe and the air vents are coupled to a separate air carrying pipe. The dry air is produced by a separate blower mounted adjacent or near the pluming fixture or an integrated blower mounted for example behind the wall.

In this manner, the shower system and plumbing fixture of the present invention accomplishes all of the forgoing objectives and provides users with an improved plumbing fixture that is capable of dispensing water through water nozzles and blowing dry air through air vents. The plumbing fixture is coupled to a blower for receiving dry air and has sensors for automatically blowing the dry air as well as for setting and maintaining a suitable temperature of the air. The system and the plumbing fixture also provides buttons or other switches to manually dispense water and blow air and thus dry off the user after a shower to eliminate use of or need for a towel.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a plumbing fixture for dispensing water and blowing dry, temperate, heated or hot air. The plumbing fixture offers a way for people to bathe, shower and then dry off without having to use a towel. The plumbing fixture such as a showerhead, nozzle, faucet, spout, spigot or other suitable fixture or combinations of fixtures when the bathing enclosure includes multiple heads to enhance the bathing experience, further includes a plurality of water nozzles for dispensing water in the form of a spray or other dispersal pattern, a plurality of air vents for blowing out dry air, a timer preconfigured with a timer value and configured to calculate time from the activation of dispensing of water or cessation of the water dispensing, such that the dry or heated air is automatically started upon reaching the timer value to the preconfigured value. The water nozzles are coupled to a water carrying pipe and the air vents are coupled to a separate air carrying pipe. The dry air is produced in a separate blower that may be retrofitted to the shower or bathing area or an integrated blower with the bathing system.

In yet another embodiment, the plumbing fixture has an LED configured to blink when the timer value is approaching the preconfigured value for indicating to a user about the potential activation of blowing dry air. The system may be provided with a manual override switch such that if the user has not completed showering or bathing they may delay activation of the air.

In yet another embodiment, the plumbing fixture has a proximity sensor configured for deactivating dispensing of water or stopping blowing of dry air when motion is not detected near the plumbing fixture or in the shower or bathing area.

In yet another embodiment, the plumbing fixture has an air flow controller for modulating the flow of dry air blowing from the fixture as well as for moderating the temperature of the air.

In yet another embodiment of the present invention, a bathing system for dispensing water spray or other dispersal pattern and blowing ambient, heated or hot air from the fixture or an accessory fixture is disclosed. The shower or bathing system includes at least one plumbing fixture for dispensing water, an air carrying pipe, a water carrying pipe, a blower connected to a heater, and wall mounted diverter or mixer. The plumbing fixture has a plurality of water nozzles for dispensing a spray or other selected dispersal pattern, a plurality of air vents for blowing dry, ambient, heated or hot air. The air is produced by the blower and is carried to the vents by the air carrying pipe. The dispensing of water and blowing of air are mutually exclusive to one other such that a user can use the air drying feature to dry off after taking a shower or completing the bathing and thus eliminates use of a towel.

In yet another embodiment, the plumbing fixture such as a showerhead has a dry air blower button or switch for manually activating the blowing or release of dry, ambient, cool, heated or hot air and has a water dispenser button for manually activating the dispensing of water through a spray or other selected dispersal pattern.

In yet another embodiment of the present invention, the air passes through vents and is adjustable and the water passes through nozzles is adjustable, thereby allowing a user to regulate the flow of water and the type of pattern they wish to use to receive the water. For example, the spray can be distributed in a water saving mode, massaging mode or other suitable water flow.

In yet another embodiment of the present invention, a plumbing fixture such as a showerhead, faucet, nozzle, spigot, spout or combination thereof is disclosed. The plumbing fixture includes a faceplate having a central vent for blowing air, ambient air, cool air, heated air or hot air or some combination of air to allow a cool down for example if the user started with hot air. A plurality of nozzles are provided around the central vent for dispensing the water. The central vent is coupled to a blower for receiving air. the nozzles are coupled to a water source for receiving water for dispensing, and a switch each of the water supply and air supply is provided for manually activating and deactivating blowing of air and dispensing of water.

Advantageously, through use of the present invention, individuals can activate the system to bathe or shower as normal. Once bathing is complete, the users can activate the blow-drying system. Ambient, cool, warm, dry or hot air is deployed from the at least one plumbing fixture to dry the user's body and hair. The system effectively eliminates the need for a towel.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the bathing enclosure and drying system of the present invention in accordance with the disclosed architecture, with an inset illustrating a close-up view of the showerhead;

FIG. 2 illustrates a block diagram view of the various potential additional components of the plumbing fixture of the present invention in accordance with the disclosed architecture;

FIG. 3 illustrates a detailed and exploded view of one potential embodiment of the plumbing fixture of the present invention in accordance with the disclosed architecture;

FIG. 4 illustrates a perspective view showing the wall panel mounted variant of one potential embodiment of the plumbing fixture of the present invention in accordance with the disclosed architecture;

FIG. 5 illustrates a perspective view of a user using one potential embodiment of the multiple plumbing fixtures of the present invention for showering and drying off using air blown from the various fixtures in accordance with the disclosed architecture; and

FIG. 6 illustrates a flow chart of the various exemplary steps in automatically activating the blowing of dry air through the fixture of one potential embodiment of the plumbing fixture shower system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a shower or other bathing enclosure and at least one fixture that provides a way to dry off a person after a shower or bathing. There is also a long felt need in the art for a fixture that can blow dry, cool, ambient, heated or hot air in addition to dispensing water. Additionally, there is a long felt need in the art for a plumbing fixture such as a showerhead, faucet, spigot, or combination thereof that functions and looks like a conventional shower or bathing area. Moreover, there is a long felt need in the art for a shower or bathing system that eliminates the need for a towel to dry off after a shower or bath. Further, there is a long felt need in the art for a plumbing fixture, such as a showerhead, that can manually or automatically dispense water and then blow air on a person using the shower, substantially simultaneously after the water has stopped flowing through the fixture. Finally, there is a long felt need in the art for a shower or bathing enclosure and plumbing fixture such as a showerhead, faucet, nozzle, spigot or combination thereof that offers a way for people to bathe, shower and then dry off without having to use a towel.

The present invention, in one exemplary embodiment, is a novel shower or bathing system for dispensing water in a spray or other desired pattern and then blowing air from an integrated fixture or showerhead. The shower or bathing system has at least one plumbing fixture such as a showerhead, an air carrying pipe, a water carrying pipe, a blower connected to a heater for modifying the temperature of the air entering the shower or bathing enclosure. The at least one plumbing fixture may include a wall mounted diverter or mixer. More specifically, the at least one fixture such as a showerhead has a plurality of water nozzles for dispensing water in a spray or other desired pattern, a plurality of air vents for blowing air such that the air is produced by the blower and is carried to the vents by the air carrying pipe. The dispensing of water and blowing out of hot air are mutually exclusive to each other such that a user can dry off after taking a shower or bathing and thus eliminates use of a towel.

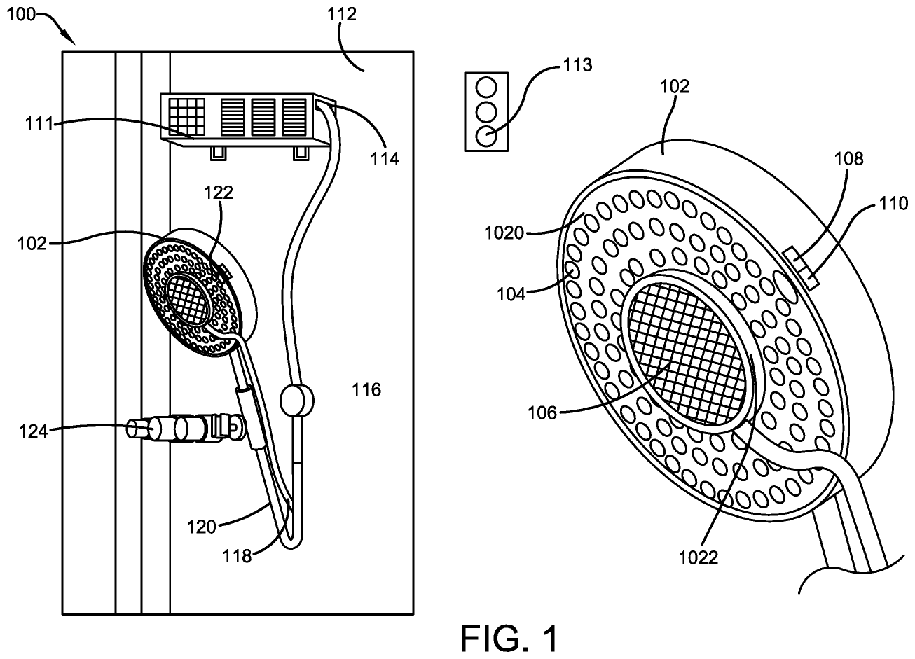

Referring initially to the drawings, FIG. 1 illustrates a perspective view of the shower or bathing system of the present invention in accordance with the disclosed specification. The shower or bathing and drying system 100 is designed for dispensing water and blowing air, which may be dry, cool, ambient, heated or hot air on a user after bathing or showering. More specifically, the system 100 has a modified plumbing fixture such as a showerhead 102 that can function as a standard plumbing fixture for bathing in addition to blowing air on the individual using the system 100. The plumbing fixture 102 may be available in a variety of configurations such as being mounted to the wall, have an extendable hose, be flexible and adjustable and have any combination of features.

The plumbing fixture such as a showerhead 102 has a faceplate 1022 and a central section 1024 on the faceplate 1022. The faceplate 1022 has a group of opening such as water nozzles 104 for dispensing water for bathing or showering. The plurality of openings or water nozzles 104 are uniformly distributed on the faceplate 1022 except the central section 1024 and the plurality openings 104 are fluidly coupled to the water carrying pipe 120. The water carrying pipe 120 is configured to carry water from a water source, such as water heater, to the plurality of openings or nozzles 104 and each opening or nozzle contributes a fluid, stream, spray or other flow of water. The nozzles or openings 104 may be angled closer towards the center 1024 of the faceplate 1022, thus creating an effective water dispersal pattern.

The central section 1024 has air vents 106 that are used for blowing air, which may be cool, ambient, heated or hot air on the user using the plumbing fixture 102. The air vents 106 can be reoriented to change the flow of the air. Further, the vents 106 are coupled to the air carrying pipe 118 such that the air carrying pipe 118 carries the air from the heater/blower 114 to the vents 106. The blower 114 may be installed on a wall 112 of a washroom and is used for producing dry or hot air. If the blower 114 is mounted on the wall the blower 114 housing 111 may be water proof to prevent water from entering the blower housing or cover. It should be understood that the blower 114 can be retrofitted to use with the shower or bathing system 100 of the present invention.

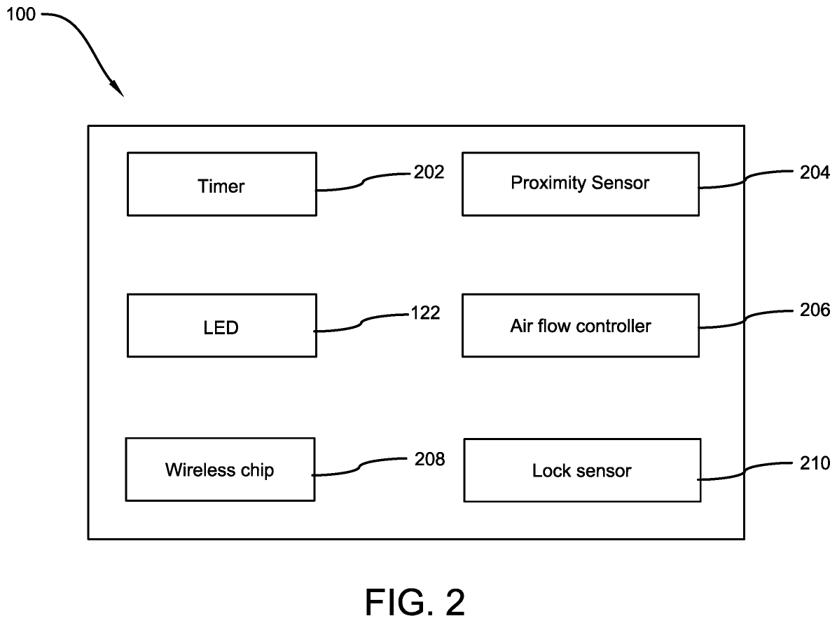

The air carrying pipe 118 and the water carrying pipe 120 may be configured as separate physical pipes or can be configured as two sections of a single pipe as per design and manufacturing preference of the user. The pipes 118, 120 are mounted to the wall 112 for easy and effective use or may be provided behind the wall if the shower or bathing system is provided as an insert over an existing bath or shower. The plumbing fixture or showerhead 102 is designed to blow air automatically based on one or more sensors and timers as best shown in FIG. 2. Alternatively, air can be blown out by the plumbing fixture such as a showerhead 102 when the air blow button or switch 108 is manually pushed or activated by the user. When the air blow button or switch 108 is pressed or activated by a user, then the air is blown through the vents 106 and the water dispensing from the nozzles 104 is automatically stopped. Similarly, for manually activating the dispensing of water from the plurality of nozzles or openings 104, the water dispenser button or switch 110 is pressed or activated by the user. The button or switch 110 initiates dispensing of water from the plurality of nozzles or openings 104 and can be used for bathing or showering by the individual. The plumbing fixture or showerhead 102 also has an LED 122 disposed to indicate to the user that air is about to be blown from the showerhead 102. An additional or second light 113, may be provided to show that the transition is about to occur, changing from red to yellow to green. This is to ensure that a user knows about the bathing or showering duration and also helps in saving water. However, if the user wishes to bath or shower for more time, then the water dispenser button or switch 110 can be pressed by the individual.

The shower system 100 has an associated control system of diverter and mixer 124 for controlling the flow of water from the plumbing fixture or showerhead 102. The diverter and mixer 124 are preferably mounted to the wall 112 and can be used by an individual to control water flow. The plumbing fixture or showerhead 102 is designed to dispense water and blow air and eliminate the use of or need for a towel as the air deployed from the dual purpose plumbing fixture or showerhead 102 is used to dry the user's body and hair.

In one embodiment of the present invention, the blower or heater for blowing out air is integrated in the plumbing fixture or showerhead 102 and can be activated upon pressing the dry air blow button or switch 108.

FIG. 2 illustrates a block diagram view showing the additional components of the plumbing fixture such as a showerhead 102 of the present invention in accordance with the disclosed specification. As shown, the plumbing fixture such as a showerhead 102 has an integrated timer 202 that is preconfigured with a timer value such as five minutes, ten minutes or the like. The timer 202 starts counting the time when the water starts to dispense from the nozzles 104 or when the water dispenser button 110 is pressed by a user. The timer 202 is used for actuating the LED 122 or light 113 to blink when the timer value configured in the timer 202 is about to complete. This allows the user to be aware about the potential initiation of the blowing of air and the drying sequence. In the preferred case, the LED 122 starts to blink one minute earlier from the exhaustion time of the timer 202.

The timer 202 may be configured using a remote device, such as a smartphone with the plumbing fixture, such as a showerhead 102. The two are paired to each other using a Bluetooth channel or other wireless connection established using the wireless chip 208. The wireless chip 208 is built-in in the plumbing fixture or showerhead 102 and allows a wireless connection with a remote handheld electronic device. The plumbing fixture or showerhead 102 has a proximity sensor 204 in case the dual purpose showerhead 102 is a wall mounted showerhead. The sensor 204 is used for deactivating dispensing of water or stopping the blowing of air when motion is not detected in the proximity of the plumbing fixture or showerhead 102. In case, the plumbing fixture or showerhead 102 is an extendable showerhead with an extension hose 505. The showerhead 102 has a lock sensor 210, such that the sensor 210 detects when the showerhead 102 is locked into a wall mounted lock and accordingly, dispensing of water or blowing of dry air is automatically stopped by the showerhead 102.

The plumbing fixture or showerhead 102 also has an airflow controller 206 that regulates the flow of air blowing out from the air vents of the at least one plumbing fixture or showerhead 102. The controller 206 may be operated using control buttons (not shown) positioned on the blower or heater 114.

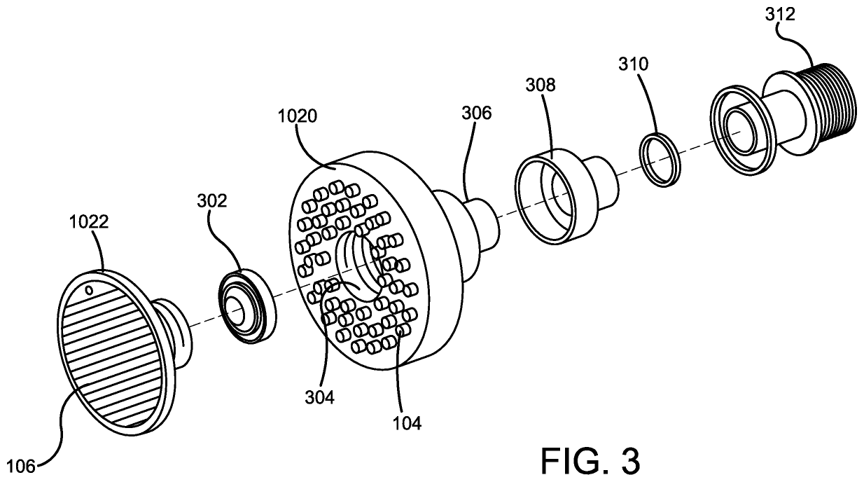

FIG. 3 illustrates a detailed exploded view of the plumbing fixture or showerhead 102 of the present invention in accordance with the disclosed specification. The plumbing fixture or showerhead 102 includes the faceplate 1020 that has water nozzles or openings 104 for dispensing water. The faceplate 1020 has a central opening 304 for receiving a connector 302 that is used for securing the central section 1022 to the faceplate 1020.

The central section 1022 is removably secured to the faceplate 1020 enabling a user to replace and repair the central section 1022. Further, the air vents 106 are disposed in the central section 1022 and are used for blowing air for drying off an individual after a shower or bath. For coupling the nozzles or openings 104 to the water pipe (shown in FIG. 1), a water nozzle coupler 306 is disposed and for coupling the air vents 106 to the air pipe (shown in FIG. 1), an air flow coupler 308 is disposed. A ring 310 is used for sealing and preventing leakage. A threaded component 312 is used for screwing the showerhead 102 to a wall or any other mounting mechanism.

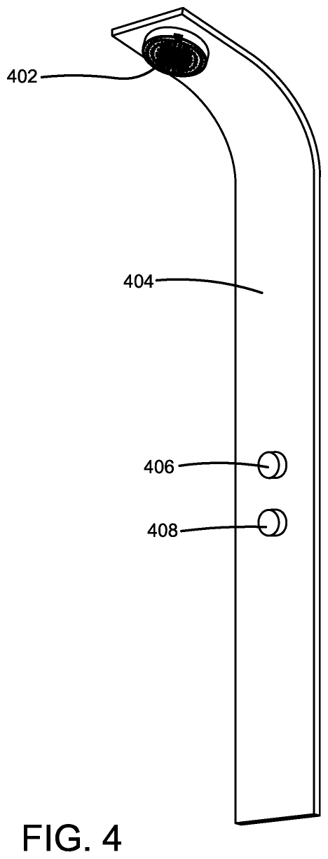

FIG. 4 illustrates a perspective view showing the wall panel mounted variant of the showerhead 102 of the present invention in accordance with the disclosed specification. As shown, the wall panel mounted showerhead 402 is mounted on the wall panel 404. The plumbing fixture or showerhead 402 has a structure as described in FIGS. 2 and 3 and is configured to blow air and dispense water for a shower or bath. The plumbing fixture or showerhead 402 has a water nozzle activation button 406 and an air blowing button 408 disposed on the wall panel 404. On pressing the water nozzle activation button 406, water is dispensed from nozzles and on pressing the drying button 408, drying air is blown from the air vents of the plumbing fixture or showerhead 402.

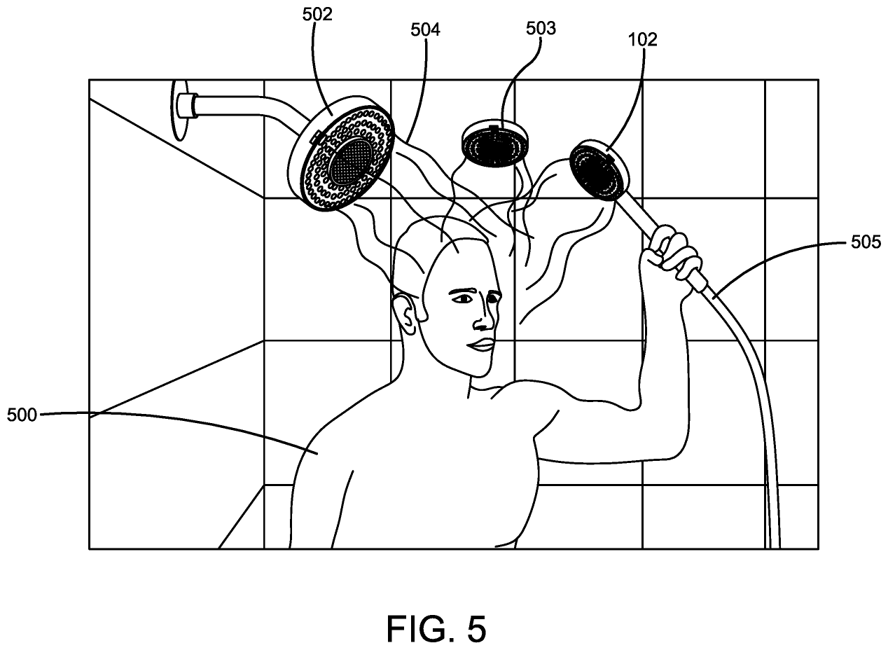

FIG. 5 illustrates a perspective view of a user using the showerheads 102, 502 of the present invention for drying off using dry air blown from the showerheads 102, 502 in accordance with the disclosed specification. The shower or bathing system may include a number of additional dispensing heads 503 for dispensing water or air, thereby enhancing the shower or bathing experience. As shown, a user 500 is using the wall mounted rotatable showerhead 502 and the extendable showerhead 102 for drying off the hair and body after a shower. The showerheads 102, 502, 503 provide drying air 504 either on manual operation by the user 500 or automatically on elapsing preconfigured time by the built-in timer. As stated earlier, the timer value can be configured remotely by the user using a handheld electronic device.

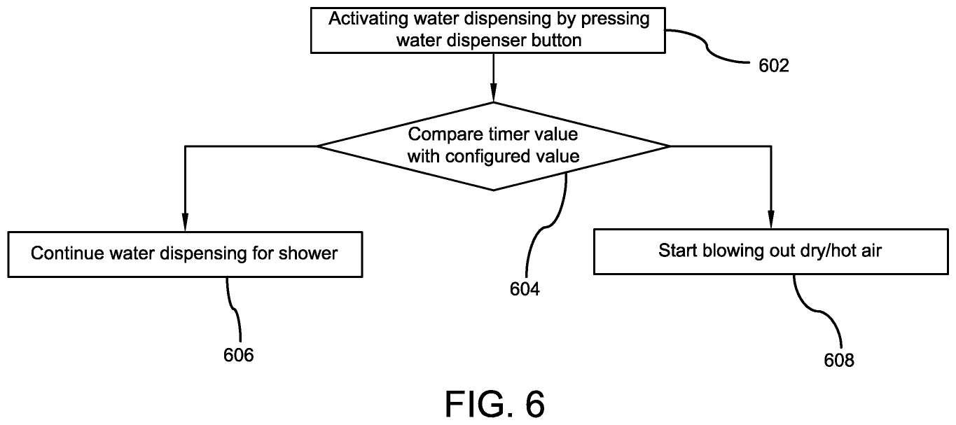

FIG. 6 illustrates a flow chart showing exemplary steps in automatically activating the drying air by the plumbing fixture or showerhead of the shower or bathing system of the present invention in accordance with the disclosed specification. As shown, initially a user activates dispensing of water in the form of a spray or other dispersal pattern from water nozzles or openings (Block 602). Then, the timer value is compared to a preconfigured timer value (Block 604). If it is determined that the timer value is less than the preconfigured timer value, then the process flows to the Block 606 where the water dispensing is continued for an individual to have the shower or bath. In case, it is determined that the timer value is elapsed and has become equal to the preconfigured timer value, then the process flows to Block 608 and the drying air is automatically blown out by the plumbing fixture or showerhead.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “shower or bathing and blow dry system”, “shower or bathing system”, and “system” are interchangeable and refer to the shower or bathing and blow dry system 100 of the present invention. Similarly, as used herein “plumbing fixture” “showerhead”, “dual purpose showerhead”, “extendable showerhead”, “wall mounted showerhead”, and “water dispensing and air blowing showerhead”, are interchangeable and refer to the water dispensing and air blowing plumbing fixture or showerhead 102 of the present invention.

Notwithstanding the forgoing, the bathing or shower and blow dry system 100 and the water dispensing and air blowing plumbing fixture or showerhead 102 of the present invention can be of any suitable size and configuration as is known in the art without affecting the overall concept of the invention, provided that it accomplishes the above-stated objectives. One of ordinary skill in the art will appreciate that the shower and blow dry system 100 and the water dispensing and air blowing plumbing fixture or showerhead 102 as shown in the FIGS. are for illustrative purposes only, and that many other sizes and shapes of the shower and blow dry system 100 and the water dispensing and air blowing showerhead 102 are well within the scope of the present disclosure. Although the dimensions of the shower and blow dry system 100 and the water dispensing and air blowing showerhead 102 are important design parameters for user convenience, the shower and blow dry system 100 and the water dispensing and air blowing showerhead 102 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A shower system comprising:
a shower enclosure;
at least one plumbing fixture mounted to the shower enclosure and comprising a face plate, wherein the face plate comprises a plurality of openings and a central vent;
a water supply connected to the at least one plumbing fixture;
an air supply connected to the at least one plumbing fixture; and
a blower connected to the air supply for providing a flow of air to the at least one plumbing fixture upon demand.

2. The shower system as recited in claim 1, wherein the blower causes the flow of air to be a select one of a dry air, a cool air, an ambient air, and a heated hot.

3. The shower system as recited in claim 1 further comprising a heater, wherein the blower is connected to the heater.

4. The shower system as recited in claim 1, wherein the plurality of openings are in fluid communication with the water supply.

5. The shower system as recited in claim 1, wherein the central vent is in fluid communication with the air supply.

6. The shower system as recited in claim 1 further comprising a timer connected to the water supply.

7. The shower system as recited in claim 1 further comprising a proximity sensor for determining a proximity of a user to the at least one plumbing fixture.

8. The shower system as recited in claim 1 further comprising an LED light for signaling activation of the blower.

9. The shower system as recited in claim 8 further comprising a second light for signaling a transition to the blower.

10. The shower system as recited in claim 1 further comprising an additional dispensing head for providing at least one of a flow of water of the flow of air.

11. The shower system as recited in claim 1 further comprising an extension hose for the at least one plumbing fixture.

12. The shower system as recited in claim 1 further comprising a timer connected to the air supply.

13. The shower system as recited in claim 1 further comprising a switch for manually controlling a flow of water or the flow of air.

14. A bathing and drying system comprising:
a bathing or showering enclosure;
at least one plumbing fixture for dispensing both a flow of air or a flow of water, wherein the at least one plumbing fixture is comprised of a central vent for providing the flow or air and a face plate having a plurality of openings for providing the flow of water;
a water supply connected to the at least one plumbing fixture and in fluid communication with the plurality of openings;
an air supply connected to the at least one plumbing fixture and in fluid communication with the central vent;
a blower connected to the air supply; and
a heater connected to the air supply.

15. The bathing and drying system as recited in claim 14, wherein the flow of air provided by the blower is a select one of a dry air, a cool air, an ambient air, and a heated air.

16. The bathing and drying system as recited in claim 14 further comprising a proximity sensor for determining a proximity of an individual to the at least one plumbing fixture.

17. The bathing and drying system as recited in claim 14, wherein the at least one plumbing fixture is a showerhead, a faucet, a nozzle, a spigot or a combination thereof.

18. The bathing and drying system as recited in claim 14 further comprising a timer in communication with the blower for activating the blower upon cessation of the flow of water.

19. The bathing and drying system as recited in claim 14 further comprising a second plumbing fixture.

20. A system for showering or bathing comprising:
a showerhead having a plurality of nozzles for providing a supply of water and a central vent for providing a flow of air;
a blower connected to the showerhead for providing the flow of air;
a heater connected to the blower for heating the flow of air before it is dispensed through the central vent;
a sensor for determining a proximity of a user to the showerhead; and
a timer connected to the blower and the showerhead for actuating the blower upon cessation of the supply of water.
